(19) United States
(12) Patent Application Publication
(10) Pub. No.: US 2026/0022133 A1
(43) Pub. Date: Jan. 22, 2026

(54) METHOD FOR CONTROLLING SIZE OF METAL-ORGANIC FRAMEWORK

(71) Applicant: INDUSTRY-ACADEMIC COOPERATION FOUNDATION GYEONGSANG NATIONAL UNIVERSITY, Jinju-si, Gyeongsangnam-do (KR)

(72) Inventors: Ju Yeong KIM, Jinju-si, Gyeongsangnam-do (KR); Jae Deok LEE, Jinju-si, Gyeongsangnam-do (KR); Su Hyeon PARK, Jinju-si, Gyeongsangnam-do (KR); Seo Jeong WOO, Changwon-si, Gyeongsangnam-do (KR); Sang Yong NAM, Sacheon-si, Gyeongsangnam-do (KR); Cheong Won BAE, Jinju-si, Gyeongsangnam-do (KR); Ye Ram KIM, Changwon-si, Gyeongsangnam-do (KR); Jeong Eon KIM, Jinju-si, Gyeongsangnam-do (KR)

(73) Assignee: INDUSTRY-ACADEMIC COOPERATION FOUNDATION GYEONGSANG NATIONAL UNIVERSITY, Jinju-si, Gyeongsangnam-do (KR)

(21) Appl. No.: 18/874,867

(22) PCT Filed: Jun. 15, 2023
(86) PCT No.: PCT/KR2023/008320

§ 371 Date: Oct. 9, 2025

(30) Foreign Application Priority Data
Jun. 17, 2022 (KR) 10-2022-0074086

(51) Int. Cl. C07F 3/06; C01B 39/00

(52) U.S. Cl. CPC C07F 3/06; C01B 39/00

(57) ABSTRACT

A method of controlling the size of a metal-organic framework, includes: preparing an emulsion by mixing an aqueous solvent and a volatile organic compound; preparing a suspension by introducing the prepared emulsion and a metal precursor into an aqueous solution containing an organic ligand precursor, and stirring a resulting mixture; and obtaining a metal-organic framework with a controlled size by centrifuging the prepared suspension, removing a resulting supernatant, and dispersing a resulting pellet in an organic solvent.

### CROSS-REFERENCE TO PRIOR APPLICATIONS

This Application is a National Stage Patent Application of PCT International Application No. PCT/KR2023/008320 (filed on Jun. 15, 2023), which claims priority to Korean Patent Application No. 10-2022-0074086 (filed on Jun. 17, 2022), which are all hereby incorporated by reference in their entirety.

### BACKGROUND

The present invention relates to a method of controlling the size of a metal-organic framework, and more specifically, to a method of variously controlling the size of a metal-organic framework by adding a small amount of an emulsifying liquid.

Metal-organic frameworks (MOFs) are porous materials in which a cluster including a metal ion or a metal is linked with an organic ligand, and are a type of coordination polymer. MOFs form a three-dimensional structure, are porous, and maintain strong bonds, and thus they have the properties that enable them to perform various functions, such as gas storage, catalysts, drug delivery, and chemical sensors.

MOFs have the characteristics that the frame or component of the central metal-organic ligand formed may be changed and that the size (volume) of the pores may also be controlled. This has the advantage that when MOFs are used as a catalyst or for gas storage, they can maximize efficiency by having many active sites. Therefore, MOFs are considered very important in the field of gas storage and catalyst applications, and in particular, it is reported that they exhibit excellent catalytic properties in gas storage such as the storage of carbon dioxide, hydrogen, and methane.

Conventional methods for controlling the size of MOFs include a method of adding a surfactant, a method of synthesizing in an organic solvent, and a method of changing a cationic precursor. The method of adding a surfactant may control the size of MOFs by adding a surfactant such as cetyltrimethylammonium bromide (CTAB) during the aqueous phase synthesis of MOFs, but since CTAB is a solid substance at room temperature, an additional washing process may be required to cleanly remove it in order to utilize the MOFs with a controlled size, and there is a problem that recovery and reuse are difficult.

In addition, the method of synthesizing in an organic solvent is to control the size by synthesizing MOFs in an organic solvent, typically methanol. The method can synthesize small-sized MOFs without additional additives, but it has problems that the size is difficult to control and the method is not environment-friendly because it basically uses a large amount of organic substances that are harmful to the environment.

Accordingly, a new method is needed to solve the existing problems and to control the size of MOFs in an easy, simple, and environment-friendly manner.

### SUMMARY

An object of the present invention is to provide a method of easily and conveniently controlling the size of a metal-organic framework (MOF) to various sizes.

To achieve the object, the present invention provides a method of controlling the size of a metal-organic framework (MOF), the method including: a step of preparing an emulsion by mixing an aqueous solvent and a volatile organic compound; a step of preparing a suspension by introducing the prepared emulsion and a metal precursor into an aqueous solution containing an organic ligand precursor, and stirring a resulting mixture; and a step of obtaining an MOF with a controlled size by centrifuging the prepared suspension, removing a resulting supernatant, and dispersing a resulting pellet in an organic solvent.

The volatile organic compound may be one or more selected from the group consisting of benzene, toluene, styrene, xylene, diethylbenzene, ethylbenzene, propylbenzene, butylbenzene, and mesitylene.

The emulsion may be prepared by mixing 0.001 to 1 part by volume of the volatile organic compound based on 100 parts by volume of the total volume of the aqueous solvent.

The organic ligand precursor may be one or more selected from the group consisting of 2-methylimidazole, ethanedioic acid, propanedioic acid, butanedioic acid, pentanedioic acid, o-phthalic acid, m-phthalic acid, p-phthalic acid, benzene-1, 4-dicarboxylic acid, benzene-1, 3, 5-tricarboxylic acid, 2-hydroxy-1, 2, 3-propanetricarboxylic acid, 1H-1, 2, 3-triazole, 1H-1, 2, 4-triazole, and 3,4-dihydroxy-3-cyclobutene-1, 2-dione.

The metal precursor may be one or more zinc precursors selected from the group consisting of zinc nitrate hexahydrate (Zn(NO₃)₂·6H₂O), zinc acetate dihydrate (Zn(CH₃CO₂)₂·2H₂O), and zinc sulfate hexahydrate (ZnSO₄·6H₂O).

The step of preparing the suspension may be performed by injecting the metal precursor and the prepared emulsion into the aqueous solution at a volume ratio of 1: (0.1 to 1).

The step of obtaining an MOF may be performed by centrifuging the prepared suspension at 5,000 to 10,000 rpm for 5 to 30 minutes and then removing a supernatant.

In the method, the average diameter of the MOF may be controlled to a range of 100 to 3,000 nm.

In addition, the present invention provides a size-controlled MOF according to the method.

The MOF may have an average diameter controlled to a range of 100 to 3000 nm.

According to the method of controlling the size of an MOF according to the present invention, the size of an MOF can be variously controlled through an easy and simple process.

By using the method according to the present invention, problems with the conventional size control method can be solved, and harmful effects on the environment can be reduced by adding a small amount of volatile organic compound.

In addition, by using the method, the MOF can be appropriately controlled to a size suitable for a field to which it is applied, thereby increasing efficiency and allowing it to be utilized in various fields.

### BRIEF DESCRIPTION OF THE DRAWINGS

FIG. 1 shows an absorption spectrum of a zeolitic imidazolate framework-8 (ZIF-8) dispersion synthesized according to one embodiment of the present invention according to the volume of o-xylene added.

FIG. 2 shows a scanning electron microscope (SEM) image of ZIF-8 of FIG. 1.

FIG. 3 shows an absorption spectrum of a ZIF-8 dispersion synthesized according to another embodiment of the present invention according to the presence and length of dialkyl groups.

FIG. 4 show a SEM image of ZIF-8 of FIG. 3.

FIG. 5 shows an absorption spectrum of a ZIF-8 dispersion according to the length of a single-chain alkyl group.

FIG. 6 shows a SEM image of ZIF-8 of FIG. 5.

FIG. 7 shows an absorption spectrum of a ZIF-8 dispersion according to the number of alkyl groups.

FIG. 8 shows a SEM image of ZIF-8 prepared with an emulsion containing mesitylene.

FIG. 9 shows a schematic diagram comparing a conventional ZIF-8 synthesis method and a synthesis method according to the present invention.

### DETAILED DESCRIPTION

Hereinafter, the present invention will be described in detail.

The terms used in the present invention are selected from terms that are currently used as commonly as possible while considering the functions of the present invention, but they may vary depending on the intention of one of ordinary skill in the art, precedents, the emergence of new technologies, and the like. Therefore, the terms used in the present invention should be defined based on the meaning of the terms and the overall contents of the present invention, rather than simply the names of the terms.

Throughout the present specification, when a part is said to “include” a certain component, unless specified otherwise, this means that it may further include other components, rather than exclude other components.

The present invention provides a method of controlling the size of an MOF.

More specifically, the method may include: a step of preparing an emulsion by mixing an aqueous solvent and a volatile organic compound; a step of preparing a suspension by introducing the prepared emulsion and a metal precursor into an aqueous solution containing an organic ligand precursor, and stirring a resulting mixture; and a step of obtaining a metal-organic framework with a controlled size by centrifuging the prepared suspension, removing a resulting supernatant, and dispersing a resulting pellet in an organic solvent.

In the present invention, the step of preparing an emulsion may be performed by mixing an aqueous solvent and a volatile organic compound

The above aqueous solvent may be a solvent containing water, and may preferably be pure water or de-ionized water, which is highly purified from water which inorganic substances, particulates, bacteria, microorganisms, or the like in water have been removed, but is not limited thereto.

The volatile organic compound is a general term for liquids or gaseous organic compounds that have a low boiling point and thus easily evaporate into the air, and it may include most hydrocarbons such as liquid fuels, paraffins, olefins, and aromatic compounds with a low boiling point, and preferably include one or more selected from the group consisting of benzene, toluene, styrene, xylene [ortho- , meta- , para- ], diethylbenzene, ethylbenzene, propylbenzene, butylbenzene, and mesitylene, but is not limited thereto.

The emulsion may be prepared by mixing 0.001 to 1 part by volume of the volatile organic compound based on 100 parts by volume of the total volume of the aqueous solvent, and preferably, by mixing 0.001 to 0.5 parts by volume of the volatile organic compound, but is not limited thereto. The emulsion can also reduce harmful effects on the environment by being prepared by including a trace amount of the volatile organic compound.

In the present invention, the step of preparing a suspension by introducing a metal precursor and the prepared emulsion into an aqueous solution containing an organic ligand precursor, and stirring a resulting mixture.

The organic ligand precursor may one or more selected from the group consisting of 2-methylimidazole, ethanedioic acid, propanedioic acid, butanedioic acid, pentanedioic acid, o-phthalic acid, m-phthalic acid, p-phthalic acid, benzene-1, 4-dicarboxylic acid, benzene-1, 3, 5-tricarboxylic acid, 2-hydroxy-1, 2, 3-propanetricarboxylic acid, 1H-1, 2, 3-triazole, 1H-1, 2, 4-triazole, and 3, 4-dihydroxy-3-cyclobutene-1, 2-dione, and preferably 2-methylimidazole, but is not limited thereto.

The metal precursor may be one or more zinc precursors selected from the group consisting of a nitrate, an ammonium salt, a sulfate, a halide, an oxalate, an acetate, and an acetylacetonate containing zinc, preferably one or more selected from the group consisting of zinc nitrate hexahydrate (Zn(NO₃)₂·6H₂O), zinc acetate dihydrate (Zn(CH₃CO₂)₂·2H₂O), and zinc sulfate hexahydrate (ZnSO₄·6H₂O), more preferably zinc nitrate hexahydrate, but is not limited thereto.

The organic ligand precursor may be dissolved in an aqueous solvent, and the aqueous solvent means that the solvent is water or a mixture containing water of 40% by weight or more, preferably 50% by weight or more, based on the total weight of the solvent.

The aqueous solution containing an organic ligand precursor may have a concentration of 0.5 to 2 M, but is not limited thereto.

The metal precursor may be a metal precursor hydrate or may be dissolved in an aqueous solvent, and may have a concentration of 10 to 30 mM, but is not limited thereto.

The organic ligand precursor and the metal precursor may be included in a molar ratio of (50 to 60):1 to form an MOF.

The metal precursor and the prepared emulsion may be injected into the aqueous solution containing the organic ligand precursor at a volume ratio of 1: (0.1 to 1), and the resulting mixture may be stirred to prepare a suspension, and preferably, the aqueous solution, the metal precursor, and the prepared emulsion may be mixed at a volume ratio of 1:1:1 and the resulting mixture may be stirred to prepare a suspension, but are not limited thereto.

The metal precursor and the prepared emulsion may be sequentially injected into the aqueous solution, or may be injected simultaneously, but are not limited thereto.

The suspension prepared by stirring may be allowed to stand at room temperature for one hour or more, preferably for three hours or more, and the suspension may include an MOF with different sizes.

In the present invention, the step of obtaining the MOF with a controlled size may be performed by centrifuging the prepared suspension, removing a supernatant, and dispersing a pellet in an organic solvent.

The prepared suspension may be centrifuged at 5,000 to 10,000 rpm for 5 to 30 minutes to remove a supernatant and disperse a pellet in an organic solvent such as methanol, ethanol, propanol, or butanol to obtain an MOF.

The obtained MOF may have an average diameter in the range of 100 to 3000 nm, which may be controlled depending on the type of the prepared emulsion.

In addition, the present invention provides an MOF with a controlled size according to the method.

The MOF may have an average diameter in the range of 100 to 3000 nm, and the average diameter may be controlled depending on the type of the prepared emulsion.

More details will be described later in the following experimental examples.

Hereinafter, in order to help understand the present invention, examples will be given and described in detail. However, the following examples are only intended to illustrate the content of the present invention, and the scope of the present invention is not limited to the following examples. The examples of the present invention are provided to more completely explain the present invention to one of ordinary skill in the art.

### PREPARATION EXAMPLE 1 REAGENTS

The reagents used were as follows, and all reagents were used without purification after purchase:

2-methyl imidazole (99%, Sigma-Aldrich), zinc nitrate hexahydrate (98%, Sigma-Aldrich), o-xylene (98%, Samchun), benzene (99.8%, Sigma-Aldrich), methanol (99.5%, Daejung), cobalt nitrate (99.999%, Alfa Aesar), mesitylene (98%, Sigma-Aldrich), 1,2-diethylbenzene (99.0%, Sigma-Aldrich), toluene (99.7%, Daejung), ethylbenzene (99%, Sigma-Aldrich), propylbenzene (98%, Sigma-Aldrich), and butylbenzene (99%, Sigma-Aldrich).

### EXAMPLE 1 SYNTHESIS OF ZEOLITIC IMIDAZOLATE FRAMEWORK-8 (ZIF-8)

0.5 mL of 1.32 M 2-methyl imidazole was injected into a 20 mL vial, and while stirring at 500 rpm, 0.5 mL of 24 mM Zn(NO₃)₂ was injected, and the resulting mixture was stirred for five minutes and then allowed to stand at room temperature for three hours. Thereafter, the suspension was centrifuged at 6,000 rpm for 10 minutes, the supernatant was removed, and the pellet was dispersed in methanol. The dispersion was centrifuged at 6,000 rpm for 10 minutes, the supernatant was removed, and the pellet was dispersed in methanol, and the resulting dispersion was stored.

### EXAMPLE 2 ZIP-8 SYNTHESIS THROUGH EMULSION ADDITION: CONFIRMATION OF THE EFFECT OF O-XYLENE ADDITION VOLUME

0.5 mL of 1.32 M 2-methyl imidazole was injected into a 20 mL vial and stirred at 500 rpm. o-xylene was injected into 100 mL of deionized water at each volume (0, 1.5, 30, 300 L) and shaken by hands five times to prepare an emulsion. 0.5 mL of 24 mM Zn(NO₃)₂ was injected into the stirred 2-methyl imidazole solution and after 10 seconds, the prepared emulsion was shaken five more times and 0.5 mL was quickly injected. The mixed solution was stirred for five minutes and then allowed to stand at room temperature for three hours. Thereafter, the suspension was centrifuged at 6000 rpm for 10 minutes, the supernatant was removed, and the pellet was dispersed in methanol. The dispersion was centrifuged at 6000 rpm for 10 minutes, the supernatant was removed, and the pellet was dispersed in methanol, and the resulting dispersion was stored.

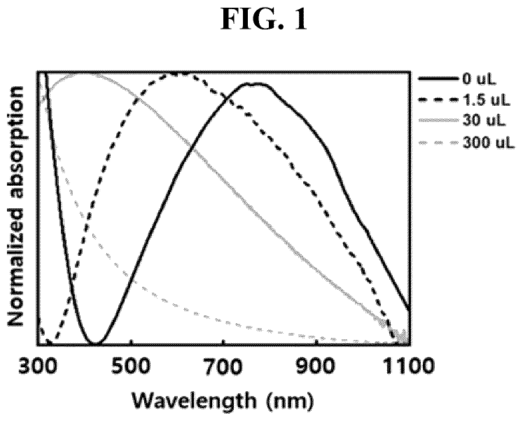

After diluting the obtained ZIF-8 particle solution 10-fold, 2 mL was injected into a 1×1 cm quartz cuvette cell and the absorption spectrum was measured. As shown in FIG. 1, it was confirmed that as the volume of o-xylene used in the preparation of the emulsion increased, the maximum absorption wavelength gradually shifted to a shorter wavelength. This means that the size of the ZIF-8 particles was controlled by the addition amount of o-xylene.

10 μL of the obtained ZIF-8 particle solution was placed on a silicon wafer, dried at room temperature, and the prepared specimen was measured using a scanning electron microscope. Platinum coating was performed to improve conductivity before the analysis.

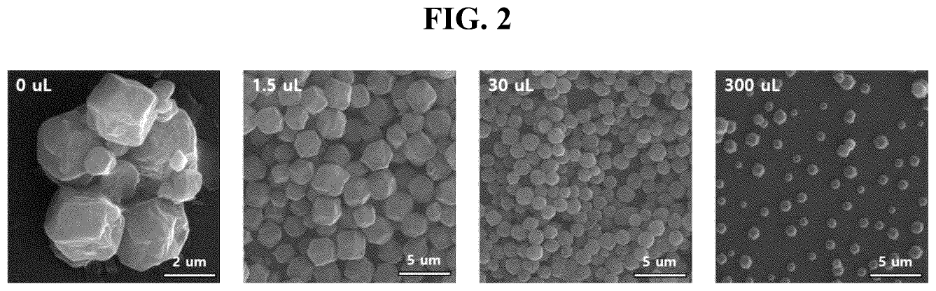

The effect of the change in the properties of the emulsion according to the volume of o-xylene on the ZIF-8 particle size was confirmed using a scanning electron microscope. As shown in FIG. 2, the ZIF-8 particles prepared without adding an emulsion were formed in the shape of a rhombic dodecahedron with an uneven surface, and the particle size was confirmed to be approximately 3340 nm.

The size of the ZIF-8 particles prepared by adding an emulsion containing 1.5 μL of o-xylene decreased to approximately 2890 nm, and the size of the ZIF-8 particles prepared by adding an emulsion containing 30 μL of o-xylene decreased to approximately 1510 nm. In particular, the size of the ZIF-8 particles prepared by adding an emulsion containing 300 μL of o-xylene significantly decreased to about 190 nm.

Through these results, it was proven that the ZIF-8 particle size can be controlled by controlling the properties of the emulsion according to the volume of o-xylene added.

### EXAMPLE 3 ZIF-8 SYNTHESIS THROUGH EMULSION ADDITION: CONFIRMATION OF THE EFFECT OF ADDING DIFFERENT SOLVENTS

0.5 mL of 1.32 M 2-methyl imidazole was injected into a 20 mL vial and stirred at 500 rpm. 300 L of each solvent (benzene, diethylbenzene, toluene, ethylbenzene, propylbenzene, butylbenzene, mesitylene) was injected into 100 mL of deionized water, and the resulting mixture was shaken quickly by hands five times to prepare an emulsion. 0.5 mL of 24 mM Zn(NO₃)₂ was injected into the stirred 2-methyl imidazole solution and after 10 seconds, the prepared emulsion was shaken 5 more times and 0.5 mL was quickly injected. The mixed solution was stirred for five minutes and then allowed to stand at room temperature for three hours. Thereafter, the suspension was centrifuged at 6000 rpm for 10 minutes, the supernatant was removed, and the pellet was dispersed in methanol. The dispersion was centrifuged at 6000 rpm for 10 minutes, the supernatant was removed, and the suspension was dispersed in methanol, and the resulting dispersion was stored.

First, the correlation between the length of the alkyl group in a molecule with two alkyl groups based on the benzene structure and the size of the ZIF-8 particles was investigated.

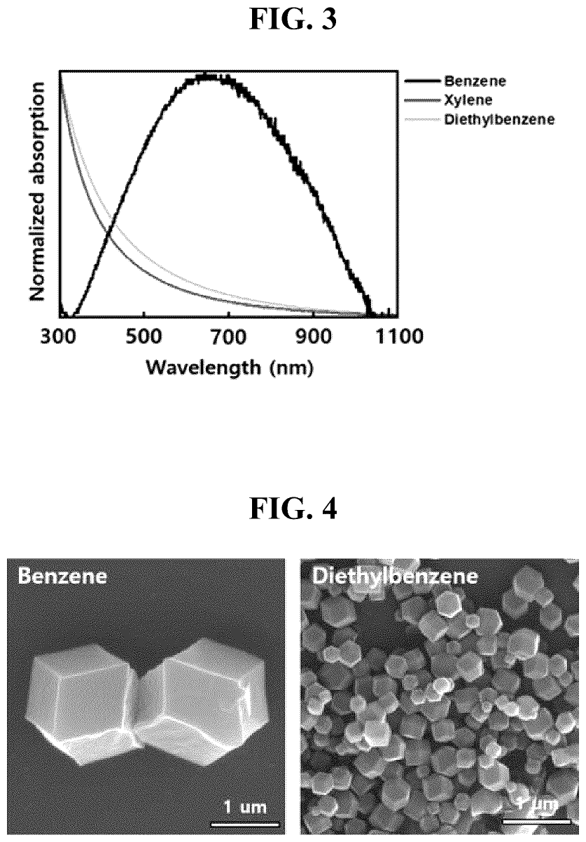

After diluting the obtained ZIF-8 particle solution 10-fold, 2 mL was injected into a 1×1 cm quartz cuvette cell and the absorption spectrum was measured. As shown in FIG. 3, it was confirmed through the absorption spectrum that, unlike the emulsion prepared by adding o-xylene or diethylbenzene, scattering by the ZIF-8 dispersion was significantly occurred when benzene was added. When benzene was used, the maximum absorbance was confirmed at around 650 nm, suggesting that ZIF-8 particles of a micrometer size were formed. When diethylbenzene was used, the maximum absorbance was confirmed at around 300 nm, suggesting that ZIF-8 particles of a size of hundreds of nanometers were formed.

10 μL of the obtained ZIF-8 particle solution was placed on a silicon wafer and dried at room temperature to prepare a specimen. The specimen was coated with platinum to improve the conductivity, and analyzed using a scanning electron microscope. As shown in FIG. 4, the size of the ZIF-8 particles prepared using benzene was confirmed to be approximately 2280 nm, and it was confirmed that particles in the shape of a rhombic dodecahedron with a considerably uniform surface were formed compared to the ZIF-8 prepared under the condition where the emulsion of FIG. 2 was not added. The size of the ZIF-8 particles prepared using diethylbenzene was approximately 350 nm, which confirmed that the particle size was significantly reduced compared to when benzene was added. A similar phenomenon of a decrease in the ZIF-8 particle size was confirmed in o-xylene (FIG. 2), so it can be concluded that the presence or absence of a dialkyl group in the benzene structure is effective in controlling the ZIF-8 size by the emulsion.

Next, the correlation between the addition of a single-chain alkyl group and an increase in the chain length based on the benzene structure and the size of the ZIF-8 particles was identified.

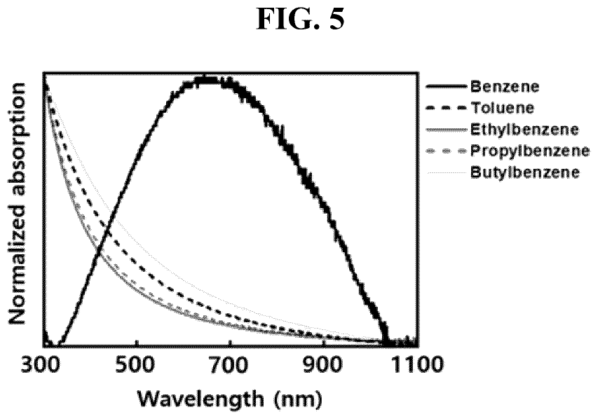

As a result, as shown in FIG. 5, when an emulsion containing toluene, ethylbenzene, propylbenzene, or butylbenzene, excluding benzene, was used, the obtained ZIF-8 showed a maximum absorbance at 300 nm, and so it was inferred that small ZIF-8 particles were formed.

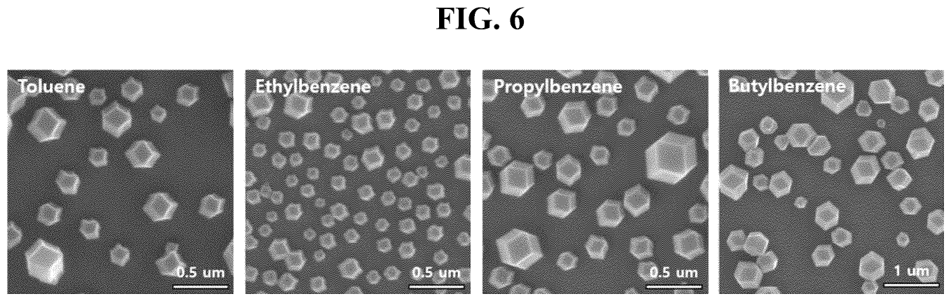

In addition, referring to FIG. 6, the size of the ZIF-8 particles prepared using toluene was approximately 310 nm, confirming that the size was significantly reduced compared to the ZIF-8 particles obtained using benzene (FIG. 4). The size of the ZIF-8 particles obtained using ethylbenzene with an increased alkyl chain length was approximately 190 nm, the size of the ZIF-8 particles obtained using propylbenzene with a further increased chain length was approximately 250 nm, and the size of the ZIF-8 particles obtained using butylbenzene was approximately 540 nm.

Through these results, it was found that the properties of the emulsion are changed by the increase of the single-chain alkyl group length in the benzene structure, and thus a method of controlling the ZIF-8 particle size in hundreds of nanometers may be provided.

Finally, the correlation between the number of alkyl groups and the ZIF-8 particle size was confirmed based on the benzene structure.

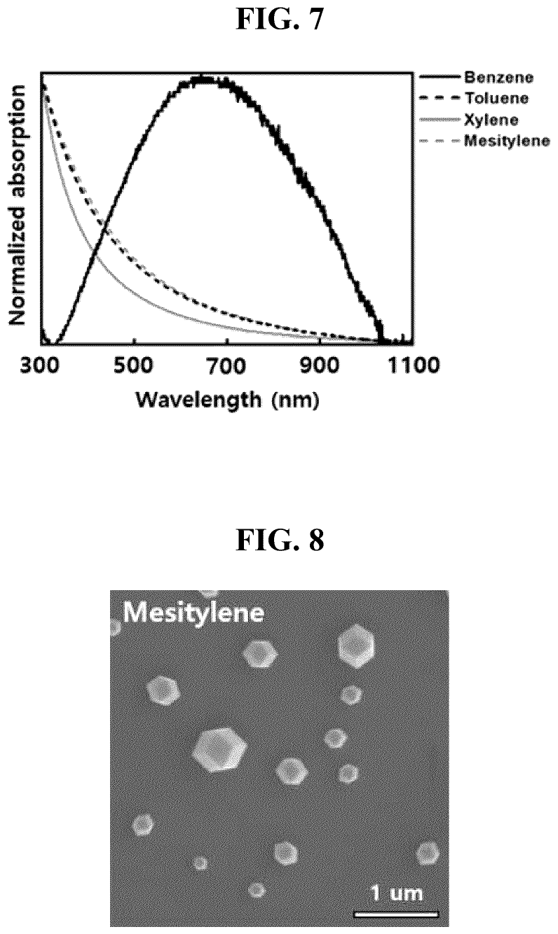

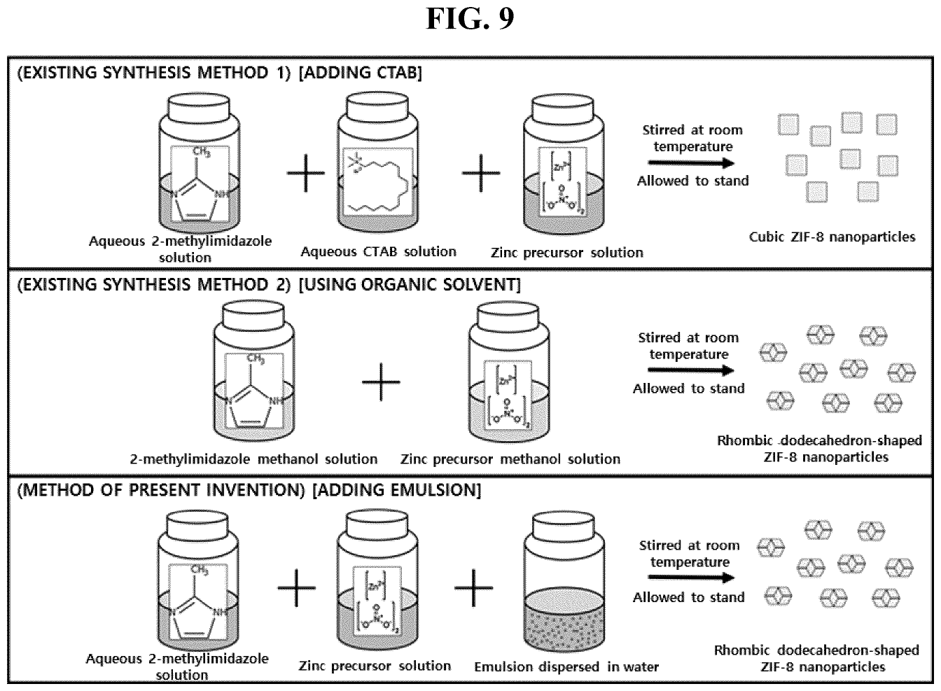

As a result, as shown in FIG. 7, it was confirmed that the ZIF-8 obtained by using an emulsion containing mesitylene with three alkyl groups exhibited an absorption spectrum similar to that of the ZIF-8 obtained by adding toluene.

In addition, referring to FIG. 8, the size of the ZIF-8 particles prepared using mesitylene was approximately 320 nm, which was similar to the size of the ZIF-8 particles prepared using toluene (FIG. 6) and larger than the size of the ZIF-8 particles prepared using o-xylene (FIG. 2).

Through these results, it was confirmed that o-xylene with two alkyl groups in the benzene structure may be used to prepare ZIF-8 particles having a smaller size than the ZIF-8 particles prepared using toluene with one alkyl group and those prepared using mesitylene with three alkyl groups.

Although specific parts of the present invention have been described in detail, it will be apparent to those skilled in the art that this description is only for a preferred embodiment and does not limit the scope of the present invention. Thus, the substantial scope of the present invention will be defined by the appended claims and equivalents thereof. The scope of the present invention is indicated by the following claims, and all changes or modifications derived from the meaning and scope of the claims and equivalents thereof should be construed as being included in the scope of the present invention.

1. A method of controlling the size of a metal-organic framework, the method comprising:
a step of preparing an emulsion by mixing an aqueous solvent and a volatile organic compound;
a step of preparing a suspension by introducing the prepared emulsion and a metal precursor into an aqueous solution containing an organic ligand precursor, and stirring a resulting mixture; and
a step of obtaining a metal-organic framework with a controlled size by centrifuging the prepared suspension, removing a resulting supernatant, and dispersing a resulting pellet in an organic solvent.

2. The method of controlling the size of a metal-organic framework according to claim 1, wherein the volatile organic compound is one or more selected from the group consisting of benzene, toluene, styrene, xylene, diethylbenzene, ethylbenzene, propylbenzene, butylbenzene, and mesitylene.

3. The method of controlling the size of a metal-organic framework according to claim 1, wherein the emulsion is prepared by mixing 0.001 to 1 part by volume of the volatile organic compound based on 100 parts by volume of the total volume of the aqueous solvent.

4. The method of controlling the size of a metal-organic framework according to claim 1, wherein the organic ligand precursor is one or more selected from the group consisting of 2-methylimidazole, ethanedioic acid, propanedioic acid, butanedioic acid, pentanedioic acid, o-phthalic acid, m-phthalic acid, p-phthalic acid, benzene-1,4-dicarboxylic acid, benzene-1,3,5-tricarboxylic acid, 2-hydroxy-1,2,3-propanetricarboxylic acid, 1H-1,2,3-triazole, 1H-1,2,4-triazole, and 3,4-dihydroxy-3-cyclobutene-1,2-dione.

5. The method of controlling the size of a metal-organic framework according to claim 1, wherein the metal precursor is one or more zinc precursors selected from the group consisting of zinc nitrate hexahydrate (Zn(NO₃)₂·6H₂O), zinc acetate dihydrate (Zn(CH₃CO₂)₂·2H₂O), and zinc sulfate hexahydrate (ZnSO₄·6H₂O).

6. The method of controlling the size of a metal-organic framework according to claim 1, wherein the step of preparing the suspension is performed by injecting the metal precursor and the prepared emulsion into the aqueous solution at a volume ratio of 1: (0.1 to 1).

7. The method of controlling the size of a metal-organic framework according to claim 1, wherein the step of obtaining a metal-organic framework is performed by centrifuging the prepared suspension at 5,000 to 10,000 rpm for 5 to 30 minutes and then removing a supernatant.

8. The method of controlling the size of a metal-organic framework according to claim 1, wherein the average diameter of the metal-organic framework is controlled to a range of 100 to 3,000 nm.

9. A metal-organic framework with a controlled size according to claim 1.

10. The metal-organic framework according to claim 9, wherein the average diameter of the metal-organic framework is controlled to a range of 100 to 3,000 nm.
